(19) United States
(12) Patent Application Publication
(10) Pub. No.: US 2015/0354269 A1
(43) Pub. Date: Dec. 10, 2015

(54) PROTECTION KITS AND PROTECTION METHODS FOR ENTRANCEWAYS

(71) Applicant: Harry Miller Company, Boston, MA (US)

(72) Inventor: Harry Miller, Weston, MA (US)

(21) Appl. No.: 14/301,150

(22) Filed: Jun. 10, 2014

(51) Int. Cl. E06B 9/00; E04B 1/62

(52) U.S. Cl. CPC E06B 9/00; E04B 1/62

(57) ABSTRACT

Kits and methods for protecting entranceways, such as elevator entranceways are disclosed. An entranceway protection kit includes a protective pad that includes padding material disposed between the pad surfaces. A pad fastener, such as a pad fastener surface, is coupled to the pad's surface and is configured and arranged to removably couple the protective pad to the entranceway. The protective pad includes a folding stitch line to enable the crisp folding of the pad around entranceway corners. The pad has a low-profile so as to no substantially decrease the clearance of the entranceway when installed. Fasteners are coupled to the entranceway with adhesive that do not leave a residue on the entranceway surface when removed. The protective pad includes baffles to stabilize the padding material. The protective pad also includes a transparent window or envelope to display information, such as floor numbers.

### TECHNICAL FIELD OF THE INVENTION

The invention relates generally to the protection of entranceways and specifically to kits and methods for the protection of elevator entranceway frames and jambs.

### BACKGROUND OF THE INVENTION

In many buildings, one must pass through an entranceway to enter the building, or if already in the building, to enter another room of the building. By their very nature, entranceways typically have a finite vertical clearance and a finite horizontal clearance. The vertical and horizontal clearances limit the size of physical objects that may pass through the entranceways.

Often, it is desirable to pass an object through an entranceway, where the object has physical dimensions that are close to, but slightly less than, the horizontal and/or vertical clearance of the entranceway. For instance, when moving into or out of a building, large objects such as furniture, appliances, and office and/or laboratory equipment must often pass through at least one entranceway of limited clearance.

Sometimes, entranceways are constructed using materials, such as metals, wood, or stone that may be prone to damage, including scratches, dents, chips, and the like, induced by the impulse generated when an object that has substantial momentum collides with the entranceway. For example, when movers are transporting a large object through a doorway, the movers may inadvertently bang the object into surfaces or surrounding walls of the entranceway.

In such cases, padding may be employed to minimize damage sustained by various surfaces. However, in order to employ such prophylactic measures, the padding must be secured to the surfaces that require protection. In order to be of practical value, the effort required to affix padding to the surfaces must be minimal and the means employed to affix the padding must have less of a visual impact than any damage that may have occurred in the counterfactual case of no padding employed. For instance, requiring the installation of hooks, or other such fasteners, into the entranceway surfaces for each instance when an object is transported through the entranceway may not be an acceptable means of protection.

When padding is affixed to walls or surfaces, the coupling mechanism must be secure and stable enough to withstand the pad's weight and also any impact forces generated by a massive object colliding with the pad. Furthermore, it is desirable that the employed padding material not be too thick. Thick padding material may significantly reduce the effective clearance of the entranceway, minimizing the size of objects that may pass through the protected entranceway.

Additionally, because entranceways often include corners between inner and outer surfaces, multiple pads or at least a foldable pad may be required. Thick padding material may increase the difficulty associated with folding the pad around a corner of the entranceway.

One common example of an entranceway of limited clearance is an elevator entranceway. Relatively large objects must frequently pass through elevator entranceways. Many multistoried buildings, such as office buildings, research laboratories, apartments, and condominiums, often include at least one elevator. Moreover, because the occupancy of such buildings varies over time, the frequency of passing large objects through such elevator entranceways is relatively high. This high frequency significantly increases the need to provide practical and user-friendly means to protect such entranceways.

Furthermore, a gap often exists between the floor and an elevator, where the gap exposes a portion of the elevator shaft. Small objects such as hooks and other fasteners used to affix padding may inadvertently fall into the elevator shaft through such a gap. It is for the benefit of these and other concerns that the present disclosure is offered.

### SUMMARY OF THE INVENTION

The present disclosure is generally directed to protection kits and protection methods for entranceways. In one embodiment, an entranceway protection kit is configured and arranged to protect at least a portion of an entranceway that includes a first entranceway surface. The entranceway protection kit includes a protective pad that has a first pad surface, a second pad surface in opposition to the first pad surface, and padding material disposed intermediate the first and the second pad surfaces. The protection kit also includes a first pad fastener surface coupled to the second pad surface; the first pad fastener surface being configured and arranged to removably couple to a first entranceway fastener surface that is removably coupled to the first entranceway surface. The first entranceway fastener surface is coupled to the first entranceway surface such that the protective pad is removably couplable thereto.

In some embodiments, the protection kit further includes a second pad fastener surface coupled to the second pad surface. The second pad fastener being configured and arranged to removably couple to a second entranceway fastener surface. The second entranceway fastener surface is coupled to a second entranceway surface such that the protective pad is removably couplable thereto. The first pad fastener surface is a first strip of fastener material that is disposed on the second pad surface. The first pad fastener surface is adjacent to and extends longitudinally along at least a portion of a first longitudinal edge of the protective pad. The second pad fastener surface is a second strip of fastener material that is disposed on the second pad surface. The second pad fastener is adjacent to and extends longitudinally along at least a portion of a second longitudinal edge of the protective pad.

In at least one of the various embodiments, the first strip of fastener material, the second strip of fastener material, the first longitudinal edge, and the second longitudinal edge of the protective pad are substantially parallel. Furthermore, each are oriented substantially vertical when the protective pad is removably coupled to the first entranceway surface and the second entranceway surface.

In at least some embodiments, the first pad fastener surface includes a first fastener material that covers at least a portion of a surface area of the second pad surface. The first pad fastener surface is further configured and arranged to simultaneously couple to a plurality of entranceway fastener surfaces that each includes a second fastener material.

The first pad fastener surface includes, in at least one embodiment, an area of a first fastener material. The first pad fastener surface is defined by a pad fastener length and a pad fastener width. The pad fastener length is substantially greater than the pad fastener width. The first entranceway fastener surface includes an area of a second fastener material. The first entranceway fastener surface is defined by an entranceway fastener length and an entranceway fastener width. The entranceway fastener width is larger than the pad fastener width.

In at least one embodiment, the pad fastener width is approximately 1 inch and the entranceway fastener width is approximately 2 inches. The pad fastener length is approximately equal to a length of the protection pad.

In various embodiments, a second pad fastener surface is coupled to the second pad surface. The second pad fastener surface is configured and arranged to removably couple to a second entranceway fastener surface. The second entranceway fastener surface is coupled to a second entranceway surface such that the protective pad is removably couplable to the second entranceway surface. The first entranceway surface and the second entranceway surface form a corner of the entranceway. The protective pad further includes a folding stitch line disposed intermediate the first pad fastener surface and the second pad fastener surface. The folding stitch line being configured and arranged to enable folding the protective pad around the corner of the entranceway. The folding stitch line may be closer to one of the first or the second pad fastener surfaces than the other first or second pad fastener surfaces.

In various embodiments, the entranceway further includes a door oriented substantially orthogonal to the first entranceway surface. The door is disposed adjacent to a longitudinal edge of the first entranceway surface. The protective pad further includes a longitudinal pad edge that, when the protective pad is coupled to the first entranceway surface, is disposed adjacent to both the door and the longitudinal edge of the first entranceway surface.

In at least one embodiment, the first entranceway surface is a first inner surface. The entranceway further includes a second inner surface in opposition to the first inner surface. The entranceway is defined by an entranceway clearance based on a distance separating the first inner surface and the second inner surface. When the protective pad is coupled to the first inner surface, the entranceway clearance remains substantially unchanged.

The entranceway protection kit, in some embodiments, further includes an indicator configured and arranged to provide information viewable from the first pad surface when the protective pad is coupled to the first entranceway surface. In various embodiments, the entranceway is an elevator entranceway. The first entranceway fastener surface is removably coupled to the first entranceway surface by an adhesive. The first pad fastener surface is coupled to the second pad surface by at least stitches. The protective pad further comprises baffles to stabilize the padding material.

In some embodiments, a method for protecting an entranceway includes coupling a first entranceway fastener to an inner entranceway surface. The method further includes coupling a second entranceway fastener to an outer entranceway surface. At least one of the first entranceway fastener or the second entranceway fastener may be a fastener surface. The inner and the outer entranceway surfaces form a corner of the entranceway such that the first entranceway fastener is oriented substantially orthogonal to the second entranceway fastener. Some embodiments further include aligning a protective pad that includes a first pad fastener and a second pad fastener, each of the pad fasteners being disposed on a second pad surface. The protective pad is aligned such that the first pad fastener is adjacent to the first entranceway fastener. The second pad fastener is adjacent to the second entranceway fastener. The protective pad substantially wraps around the corner of the entranceway. Some embodiments also include coupling the protective pad to the entranceway by removably coupling the first pad fastener to the first entranceway fastener and removably coupling the second pad fastener to the second entranceway fastener. At least one embodiment further includes folding the protective pad about a folding stitch line of the protective pad so that the protective pad substantially wraps around the corner of the entranceway.

At least one embodiment further includes coupling a third entranceway fastener to the inner entranceway surface such that the third entranceway fastener is below the first entranceway fastener. The method may also include, coupling a fourth entranceway fastener to the outer entranceway surface such that the fourth entranceway fastener is below the second entranceway fastener. Some embodiments further include removably coupling the first pad fastener to the third entranceway fastener, as well as removably coupling the second pad fastener to the fourth entranceway fastener.

The first entranceway fastener is coupled to the inner entranceway surface with an adhesive. The protective pad further includes a window that is at least partially transparent to enable viewing of at least a portion of at least one of the inner entranceway surface or the outer entranceway surface when the protective pad is coupled to the entranceway.

In various embodiments, the protective pad further includes a third pad fastener disposed on a first pad surface. The third pad fastener is configured and arranged to enable the coupling of an information-bearing surface to the first pad surface. The protective pad may further include a third pad fastener disposed on a first pad surface. The third pad fastener is configured and arranged to enable the coupling of an information-bearing surface to the first pad surface. The protective pad is a low-profile protective pad, such that when coupled to the entranceway, a clearance of the entranceway remains substantially constant.

In at least one embodiment, an entranceway protection kit is configured and arranged to protect an inner entranceway surface and an outer entranceway surface of an entranceway. The inner entranceway surface and the outer entranceway surface form a corner in the entranceway. The protection kit comprising a first entranceway fastener that is configured and arranged for coupling to the inner entranceway surface. The protection kit also comprising a second entranceway fastener that is configured and arranged for coupling to the outer entranceway surface. The protection kit further including a protective pad including a first pad fastener disposed on a second pad surface and adjacent to a first longitudinal edge of the protective pad. The first pad fastener is configured and arranged to couple to the first entranceway fastener. The pad also includes a second pad fastener disposed on the second pad surface and adjacent to a second longitudinal edge of the protective pad, wherein the second pad fastener is configured and arranged to couple to the second entranceway fastener. The protective pad is coupled to the entranceway by employing the first and the second pad fasteners and the first and the second entranceway fasteners. At least one of the first or the second pad fasteners extends along the corresponding longitudinal edge of the protective pad.

In at least one embodiment, the protection kit also includes a folding stitch line oriented in a longitudinal direction of the protective pad. The folding stitch line disposed intermediate the first longitudinal edge and the second longitudinal edge and substantially parallel to each of the longitudinal edges. The folding stitch line is configured and arranged to enable folding the protective pad about the folding stitch line so that that the protective pad wraps around the corner of the entranceway.

In some embodiments, the protective pad is a low-profile protective pad, such that a clearance of the entranceway when the protective pad is coupled to the entranceway is substantially the same as a clearance of the entranceway remains when the protective pad is not coupled to the entranceway.

In at least one embodiment, the protection kit includes at least a total of three entranceway fasteners. In other, it may include at least five entranceway fasteners. In still other embodiments, the protection kit may include at least 10 total entranceway fasteners. In at least one embodiment, the protection kit includes a tailored lateral edge. In some embodiments, the protection kit includes at least one tailored longitudinal edge.

In various alternative embodiments, an entranceway protection kit is configured and arranged to protect at least a portion of an entranceway that includes a first entranceway surface. The entranceway protection kit includes a protective pad that includes a first pad surface, a second pad surface in opposition to the first pad surface, and padding material disposed intermediate the first and the second pad surfaces.

The entranceway kit may further include a first pad magnet that is coupled to the protective pad. The first pad magnet is configured and arranged to removably couple to the first entranceway surface. The protective pad may be removably couplable to the first entranceway surface. In at least one embodiment, the first pad magnet is coupled to the first pad surface by an adhesive.

In an alternative embodiment, the first pad magnet is disposed intermediate the first pad surface and the second pad surface and at least partially stabilized by stitches. The entranceway kit may further include a first plurality of longitudinally spaced-apart magnets that are aligned along a first longitudinal edge of the protective pad and a second plurality of longitudinally spaced-apart magnets that are aligned along a second longitudinal edge of the protective pad.

### BRIEF DESCRIPTION OF THE DRAWINGS

Preferred and alternative examples of the present invention are described in detail below with reference to the following drawings:

FIG. 1 shows an entranceway that includes a door and an entranceway frame that may be protected with the various embodiments of entranceway protection kits and protection methods disclosed herein.

FIG. 2 shows the backside of a protective pad that may be included and/or employed in various embodiments of entranceway protection kits and protection methods disclosed herein.

FIG. 3 shows an embodiment of an entranceway protection kit in mid-installation (or mid-removal) in an entranceway, such as the entranceway shown in FIG. 1, to protect the entranceway.

FIG. 4 shows another embodiment of an entranceway protection kit that is protecting a right-side portion of an elevator entranceway.

FIG. 5 shows yet another embodiment of an entranceway protection kit that is protecting a left-side portion of an elevator entranceway.

FIG. 6 shows an alternative embodiment of an entranceway protection kit in mid-installation (or mid-removal) in an entranceway, such as the entranceway shown in FIG. 1, to protect the entranceway.

### DETAILED DESCRIPTION OF THE PREFERRED EMBODIMENT

To facilitate the understanding of this invention, a number of terms are defined below. Terms defined herein have meanings as commonly understood by a person of ordinary skill in the areas relevant to the present invention. Terms such as “a,” “an,” and “the” are not intended to refer to only a singular entity, but include the general class of which a specific example may be used for illustration. The terminology herein is used to describe specific embodiments of the invention, but their usage does not limit the invention, except as outlined in the claims.

As used here, the directional terms “left” and “right” refer to the perspective of an individual that is outside of the volume that the entranceway is providing ingress and the individual is facing the entranceway and the volume to be entered into.

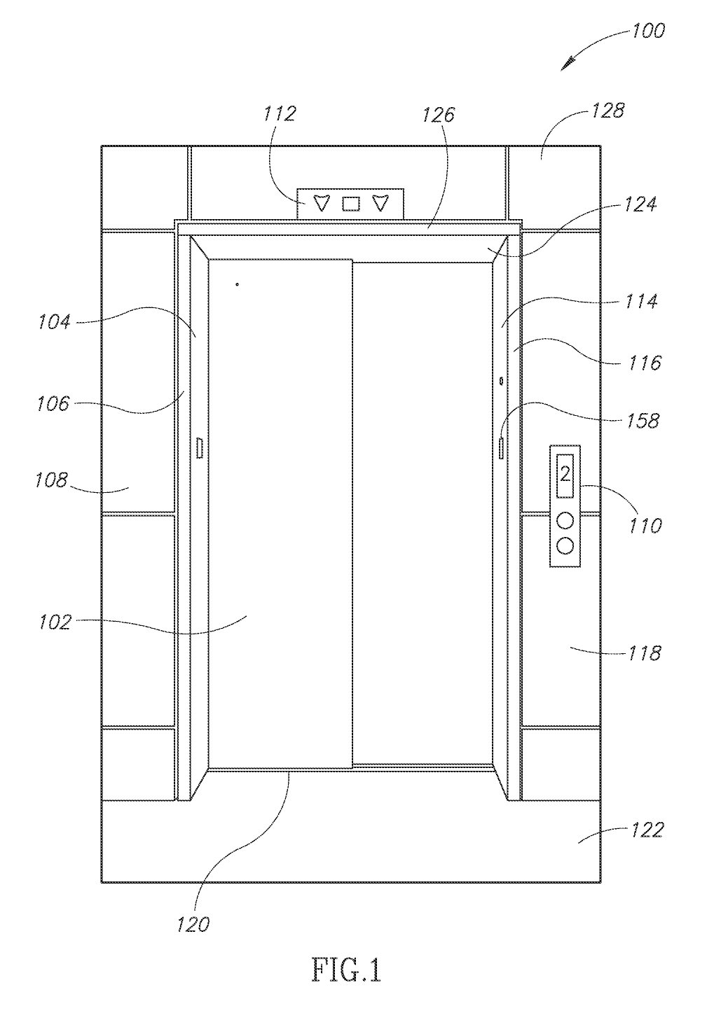

FIG. 1 shows an entranceway 100 that includes a door 102 and an entranceway frame that may be protected with the various embodiments of entranceway protection kits and protection methods disclosed herein. As shown in FIG. 1, entranceway 100 is an entranceway to an elevator. However, the various embodiments of the entranceway protection kits and protection methods are not constrained to elevator entranceways. Rather, the various embodiments discussed herein may be adapted to any type of entranceway, such as entranceways that provide ingress and egress for buildings, homes, hallways, foyers, rooms, auditoriums, theaters, laboratories, stadiums, rooms within any of these structures, or any other volume.

Elevator entranceway 100 includes door 102. As shown in FIG. 1, door 102 is an elevator door that opens and closes by slidably translating two door panels. Although elevator entranceway 100 includes a slidable elevator door 102, the various embodiments disclosed herein are not so constrained, and the various embodiments may provide protection for entranceways that do not include a door. If the entranceway to be protected does include a door, the door can be of any type of door, including, but not limited to doors that rotate about one or more hinges or pivots, doors that slide vertically or horizontally along tracks, doors that include one or more panels, and such.

Entranceway 100 includes an entranceway frame, such as an elevator entranceway frame, that may or may not be a load bearing structure. The elevator entranceway frame may be at least partially framed by left wall 108, right wall 118, floor 122, and upper wall 128. Elevator entranceway 100 may include outer elevator state indicator 112 that indicates at least one of a current floor position/location and/or direction of translation of the elevator included in the elevator shaft on the other side of elevator door 102.

Elevator entranceway 100 may include elevator external control panel 110, which may be employed to call the elevator. Additionally, external control panel 110 may be employed to input at least a direction, for instance up or down, that the user is intending to take the elevator in. In some embodiments, external control panel 110 allows the user to input the actual floor that the user intends to take the elevator. External control panel 110 may indicate a current floor position/location and/or direction of translation of the elevator. Information indicated by external control panel 110 and outer elevator state indicator 112 may inform the user of a current state of the elevator.

Elevator entranceway 100 may include entranceway floor indicator 158 that indicates the floor in the building the elevator entranceway 100 is on. Entranceway floor indicator 158 may indicate the floor via a traditional sign, a display such as a computer or light emitting diode (LED) display, or any other technology that may be employed to indicate a floor number, including braille. Entranceway floor indicator 158 is not limited to indicating information regarding a floor number, but may instead indicate any type of information that is displayable.

The elevator entranceway frame includes left inner jamb 104, which may include a left inner surface, and left outer jamb 106, which may include a left outer surface. Each of the left jambs are to the left of the exposed portion of elevator door 102. The elevator entranceway frame includes right inner jamb 114, which may include a right inner surface, and right outer jamb 116, which may include a right outer surface. Each of the right jambs are to the right of the exposed portion of elevator door 102. Additionally, in some embodiments, the elevator entranceway frame includes inner lintel 124, which may include an upper inner surface, and outer lintel 126, which may include an upper outer surface. Each of the lintels are above elevator door 102. Furthermore, the elevator entranceway may include sill 120. The sill is below elevator door 102. The elevator entranceway frame may be configured and arranged to frame elevator door 102.

In some embodiments, left inner jamb 104 and left outer jamb 106 may essentially be perpendicular in orientation and form a corner in elevator entranceway 100. Left outer jamb 106 may be substantially parallel with left wall 108. Left inner jamb 104 may be substantially perpendicular with left wall 108. Left outer jamb 106 may be flush with left wall 108 or may recessed forward or rearward of left wall 108. Left inner jamb 104 may extend forward of or rearward of left wall 108. Likewise, right inner jamb 114, right outer jamb 116, and right wall may be similarly configured. Additionally, inner lintel 124, outer liner 126, and upper wall 128 may include similar configurations.

As shown in FIG. 1, left outer jamb 106 is oriented substantially parallel with at least one of right outer jamb 116 and outer lintel 126. Left inner jamb 104 is oriented substantially parallel with right inner jamb 114. Left inner jamb 104 and right inner jamb 114 are oriented in opposition and facing each other. Left inner jamb 104 and right inner jamb 114 are separated by a distance that is approximately equal to at least one of a width of elevator door 102, a horizontal clearance of elevator entranceway 100, or a lateral clearance. Similarly, the entranceway is defined by a length of elevator door 102, a horizontal clearance, or a longitudinal clearance.

In various embodiments consistent with FIG. 1, elevator door 102 is recessed rearward of left outer jamb 106, right outer jamb 116, outer lintel 126, left wall 108, right wall 118, and upper wall 128. Furthermore, elevator door 102 is essentially flush with a distal edge of left inner jamb 104, a distal edge of right inner jamb 114, and a distal edge inner lintel 124. Also, elevator door 102 may be essentially flush with sill 120 to minimize the gap between the elevator and floor 122. The relative configurations shown in FIG. 1 creates a recessed sub-volume of which a user must pass through to pass through elevator entranceway 100. The embodiments of the entranceway protection kits and protection methods are not so constrained, and may be adapted to virtually any conceivable entranceway configuration.

The surfaces of the elevator entranceway frame may be constructed from any building material, including, but not limited to stainless steel, brushed aluminum, marble, granite, drywall, sheetrock, wood, brick, natural or synthetic paneling, ceramic tile, and the like.

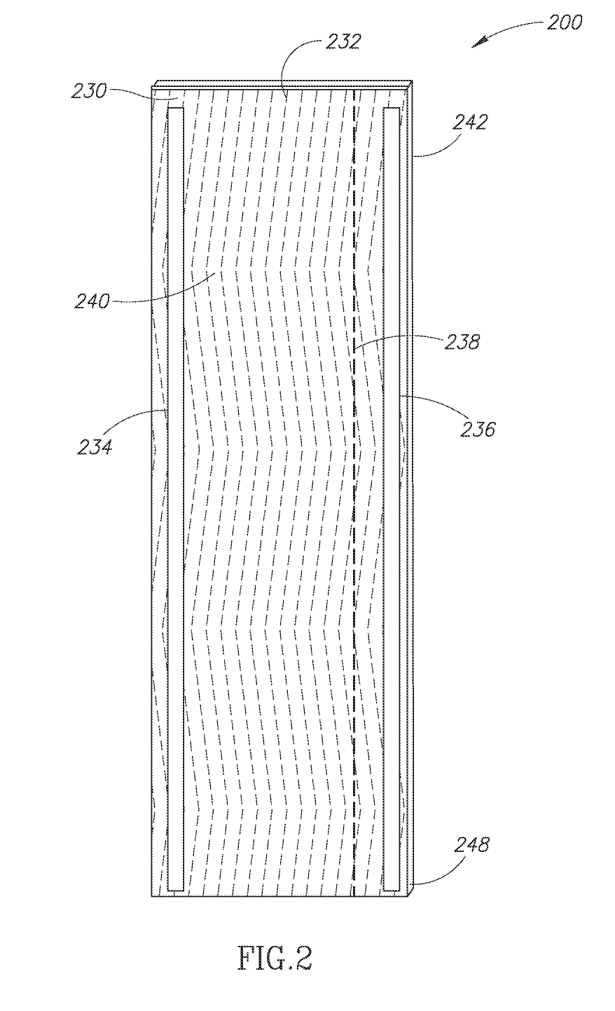

FIG. 2 shows the backside 240 of protective pad 200 that may be included and/or employed in various embodiments of entranceway protection kits and protection methods disclosed herein. The front side 242 of protective pad 200 is obscured from view in FIG. 2, but exists in opposition and is substantially parallel to the backside 240.

In various embodiments, protective pad 200 is generally takes on a rectilinear shape, however other embodiments are not so constrained, and may take on curved or non-linear shapes. As shown in FIG. 2, protective pad 200 has a general rectangular shape defined by a length (longitudinal dimension) and a width (lateral dimension). As discussed further below, protective pad also has a thickness 248.

In some embodiments, padding material is disposed between the front side 242 and the backside 240 of protective pad 200. The padding material absorbs a portion of the impulse generated by an impact to protective pad 200. The padding material may be constructed from any impact absorbing substance, such as foam or fibers.

In a preferred embodiment, protective pad 200 includes multiple padding stitch lines 232. Padding stitch lines 232 may include stitches that couple the backside 240 and the front side 242 of protective pad 200 to create padding baffles 230 or padding channels. Padding baffles 230 serve to stabilize, secure, or otherwise anchor the padding material in place. Anchoring the padding material may increase the uniformity in the distribution of padding material over the lifetime of protective pad 200, lengthen the lifetime of protective pad 200, and eliminate the formation of “soft” spots in protective pad 200.

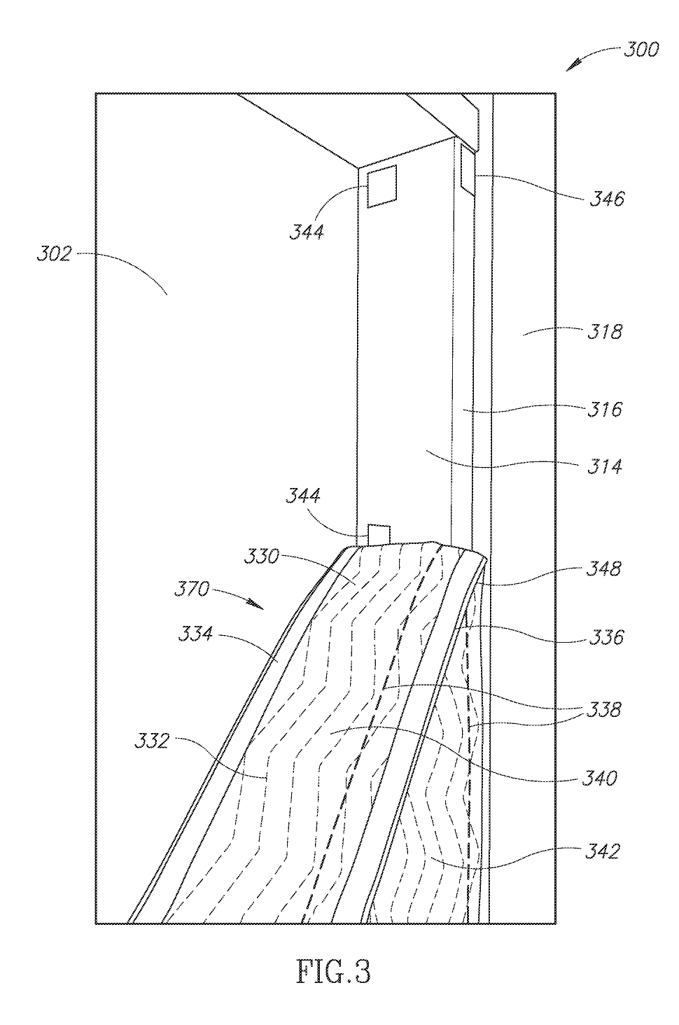

As will be discussed in the context of FIGS. 3-5, protective pad 200 is shown in a vertical orientation in FIG. 2. Thus when in use, the longitudinal direction of protective pad 200 is oriented vertically and the lateral direction of protective pad 200 is oriented horizontally. The padding stitch lines 232 shown in FIG. 2 are generally oriented along the longitudinal direction of protective pad 200. However, in order to overcome the effects of gravity and/or provide additional stabilization for the distribution of padding material, padding stitch lines 232 may have additional structure in the horizontal direction, such as a repeatable back-and-forth or zigzag, pattern, as shown in FIG. 2.

The view of protective pad shown in FIG. 2 is slightly isometric to demonstrate the thickness 248 of protective pad 200. As can be seen in FIG. 2, protective pad includes a low profile, in that the thickness 248 is significantly less than both the longitudinal length and lateral width of protective pad 200. In a preferred embodiment, the longitudinal length is larger than the lateral width of protective pad 200. In some embodiments, the thickness of the pad is less than at least one of 25%, 20%, 15%, 10%, or 5% of the width, or lateral dimension, of protective pad 200. However, the embodiments are not so constrained, and protective pad 200 may be constructed to any shape, including varying the width, length, and thickness, as required for a particular entranceway, such as entranceway 100 of FIG. 1.

As will become readily apparent in the discussion regarding FIGS. 3-5, the low profile of protective pad 200 enables the pad to protect an entranceway without significantly interfering with, or otherwise minimizing the clearance of the entranceway.

Protective pad 200 includes a first fastener, such as first pad fastener surface 234, and a second fastener, such as second pad fastener surface 236. Although fastener surfaces are discussed herein, the various embodiments are not so constrained and any fastener may be adapted for use in the various embodiments.

First pad fastener surface 234 may be disposed adjacent to, or nearly adjacent and/or substantially parallel with at least a portion of a first longitudinal edge of the backside 240 of protective pad 200. Second pad fastener surface 236 may be disposed adjacent to, or nearly adjacent, and/or substantially parallel with at least a portion of a second longitudinal edge of the backside 240 of protective pad 200. In various embodiments, at least one of the longitudinal edges or the lateral edges may be tailored for a specific entranceway geometry.

As shown in FIG. 2, first pad fastener surface 234 may be a continuous surface running along and substantially parallel with at least a portion of the longitudinal edge. Although not shown, in various other embodiments, first pad fastener surface 234 may include a plurality of discrete fastener surfaces disposed along the longitudinal edges. First pad fastener surface 234 may be a material fastener such as hook or loop material. In at least one preferred embodiment, first pad fastener surface 234 may be strip or stripe of hook material that runs along and nearly adjacent to the longitudinal edge. In some preferred embodiments, the width of the strip is approximately 1 inch and the length of the strip is approximately the length of protective pad 200. In some embodiments, second pad fastener surface 236 includes a similar construction and linear dimensions of first pad fastener surface 234. In at least one embodiment, a pad fastener surface may be a magnet.

Although first pad fastener surface 234 and second pad fastener surface 236 are shown nearly adjacent to their respective longitudinal edges, other embodiments are not so constrained. At least one of first pad fastener surface 234 and second pad fastener surface 236 may run along and parallel with the respective longitudinal edge but positioned away from or recessed from the longitudinal edge. Embodiments may vary the distance that first pad fastener surface 234 and/or second pad fastener surface 236 is recessed from the corresponding longitudinal edge by a percentage of the total width or lateral dimension of protective pad 200.

In FIG. 2, each of the pad fastener surfaces are recessed from the corresponding longitudinal edges by about 5% of the total lateral width of protective pad 200. Various embodiments may vary this percentage between 0% (flush up against the longitudinal edge) and 50% (directly at the lateral midpoint between the two longitudinal edges) for each of first pad fastener surface 234 and second pad fastener surface 236. Because the pad fastener surfaces have an inherent fastener width (as well as length), the percentage of recess may be measured from the lateral midpoint of the pad fastener surface. Either first pad fastener surface 234 or second pad fastener surface 236 may be substantially adjacent to the corresponding longitudinal edge if the percentage of recess is between 2% and 10%

The width or lateral dimension of each of the pad fastener surfaces may be characterized as a percentage of the width or lateral dimension of protective pad 200. In preferred embodiments, the width of at least one of first pad fastener surface 234 or second pad fastener surface 236 ranges between 5%-20%. Likewise, the length or longitudinal dimension of each of the pad fastener surfaces may be characterized as a percentage of the length or longitudinal dimension of protective pad 200. In preferred embodiments, the length of at least one of first pad fastener surface 234 or second pad fastener surface 236 ranges from 80-100%.

In some embodiments, at least one of first pad fastener surface 234 or second pad fastener surface 236 is coupled to the backside 240 of protective pad 200 through the use of stitches. In at least one embodiment, at least one of first pad fastener surface 234 or second pad fastener surface 236 is coupled to the backside 240 of protective pad with at least an adhesive, such as an epoxy or glue.

Protective pad 200 may include folding stitch line 238. Folding stitch line 238 may include stitches that couple the backside 240 and the front side 242 of protective pad 200. Folding stitch line 238 enables the crisp bending or folding of protective pad 200, so that protective pad 200 may wrap around and cover corners, angled surfaces, and the like included in entranceways.

The gauge of folding stitch line 238, as well as the weight of the thread used to construct folding stitch line 238 may be varied to accommodate a wide variety of types and thicknesses of padding material, as well as the specific geometries that the pad must be folded and wrapped around. The gauge of the stitch lines and the weight of thread used to construct padding stitch lines 232 may be similarly varied to accommodate the padding material and specific geometry of protective pad 200.

Folding stitch line 238, as shown in FIG. 2, is a longitudinal folding stitch line. As will become apparent in the discussion regarding FIGS. 3-5, folding stitch line 238 has been constructed to enable the crisp bending of protective pad 200 around a vertical, or longitudinal corner. However, the invention is not so constrained, and folding stitch lines may be adapted to accommodate any geometry of the entranceway to be protected. The stitch line may be positioned and oriented in view of the folds that will be needed in protective pad 200 to protect a given entranceway, such as horizontal or lateral folds. Although only a single folding stitch line 238 is shown in FIG. 2, multiple folding stitch lines may be employed to create multiple folds in protective pad 200. Padding material may be eliminated or reduced along the folding stitch line to facilitate bending in some embodiments.

FIG. 3 shows an embodiment of an entranceway protection kit in mid-installation (or mid-removal) in an entranceway, to protect the entranceway frame. Elevator entranceway 300 includes elevator door 302 and right wall 318. Elevator entranceway 300 also includes right inner jamb 314, which includes a right inner surface, and right outer jamb 316, which includes a right outer surface.

An embodiment of a protective pad 370 is shown partially coupled to and partially protecting right inner jamb 314 and right outer jamb 316. Various embodiments of a protection kit include at least one inner jamb fastener, such as inner jamb fastener surface 344. Two inner jamb fastener surfaces 344 are shown in FIG. 3. Each are coupled to the surface of right inner jamb 314 and are aligned substantially vertically with respect to each other. However, the various embodiments are not so constrained, and the vertical alignment of inner jamb fastener surfaces 344 may be staggered. In various embodiments consistent with FIG. 3, there are other inner jamb fastener surfaces that are obscured from view because the lower portion of protective pad 370 is coupled to them pad fasteners, such as first and second pad fastener surfaces 334 and 336.

Some embodiments include at least one outer jamb fastener surface 346. As with inner jamb fastener surfaces 344, there are additional outer jamb fastener surfaces 346 that are obscured from view by partially installed protective pad 370. The outer jamb fastener surfaces 346 are coupled to outer jamb 316. Similarly with inner jamb surfaces 344, outer jamb fastener surfaces 346 may be positioned in substantial vertical alignment with respect to each other, or the vertical alignment may be staggered.

As shown in FIG. 3, the horizontal position of the upper inner jamb fastener surface 344 is substantially aligned with the horizontal position of upper outer jamb fastener surface 346. In some embodiments, the horizontal positions of each of the inner jamb fastener surfaces 344 may be substantially aligned with the horizontal positions of a corresponding outer jamb fastener surface 346. In other embodiments, the horizontal positions may be staggered. In some embodiments, there are equal number of inner jamb fastener surfaces 344 and outer jam fastener surfaces 346. However, in other embodiments, there may be dissimilar number of fastener surfaces. In a preferred embodiment, there are five inner jamb fastener surfaces 344 distributed approximately uniformly along right inner jamb 314, as well as five outer jamb fastener surfaces 346 that are distributed approximately uniformly along right outer jamb 316.

In various embodiments, one or more of the jamb fastener surfaces may be a material fastener such hook or loop material. However, the disclosure is not so constrained, and any type of fastener may be employed. In at least one preferred embodiment, each of the inner jamb fastener surfaces 344 and the outer jamb fastener surfaces 346 includes a swatch of area of material. The swatch may be a symmetrical swatch, such as a 2 inch by 2 inch square of loop material. Although other embodiments may include more or less numbers of jamb fastener surfaces with other or dissimilar dimensions, such as non-symmetric configurations.

At least one of the jamb fastener surfaces, such as one of the inner jamb fastener surface 344 or outer jamb fastener surfaces, may be coupled to a jamb surface, such as those included in right inner jamb 314 or right outer jamb 316, with an adhesive epoxy, resin, or glue. In a preferred embodiment, an epoxy is used to couple each of the jamb fastener surfaces to one or more jamb surfaces. In some of the various embodiments, at least one of inner jamb fastener surfaces 344 or outer jamb fastener surfaces 346 are separate surfaces from any of the surfaces included in an entranceway, such as elevator entranceway 300. A fastener surfaces may be a flat, substantially 2D, or planer surface.

After protective pad 370 is de-coupled from elevator entranceway 300, each of the jamb fastener surfaces may be removed from the jamb surfaces, without the epoxy leaving a significant residue behind. In the event that any of the adhesive is left behind, the residual adhesive may be removed from jamb surfaces, such as stainless steel, aluminum, granite, or marble, by lightly scraping it off in such a way that will not mar or otherwise visibly damage the surface. The residue may alternatively be removed with a cleaning agent.

As shown in FIG. 3, protective pad 370 includes a first pad fastener, such as first pad fastener surface 334, and second pad fastener, such as second pad fastener surface 336. To removably couple protective pad 370 to right inner jamb 314, first pad fastener surface 334 is coupled to at least one the inner jamb fastener surfaces 344. Likewise, to removably couple protective pad 370 to right outer jamb 316, second pad fastener surface 336 is coupled to at least one the outer jamb fastener surfaces 346.

First pad fastener surface 334 may be coupled to more than one inner jamb fastener surface 344, to increase and secure the stability and strength of coupling protective pad 370 to right inner jamb 314. Likewise, second pad fastener surface 336 may be coupled to more than one outer jamb fastener surface 346. In a preferred embodiment, enough jamb fastener surfaces are employed, on both right inner jamb 314 and right outer jamb 316, to support the weight of protective pad 370 and to securely stabilize protective pad 370 in the event of any collisions with massive objects passing through elevator entranceway 300.

In a preferred embodiment, to enable the alignment of the first and the second pad fastener surfaces 334/336 with the inner and outer jamb fastener surfaces 344/346 respectively, the width of the jamb fastener surfaces 344/346 are wider than the widths of the first and the second pad fastener surfaces 334/336. For instances, the width of each of the jamb fastener surfaces may be 2 inches and the width of each of the pad fastener surfaces may be 1 inch. In an alternative embodiment, the width of the pad fastener surfaces are wider than the width of the jamb fastener surfaces.

Although not shown, in order to enhance the ease of aligning the first and second pad fastener surfaces 334/336 with inner and outer jamb fastener surfaces 344/346 respectively, outlines or other visual representations of the positioning and/or orientation of the pad fastener surfaces, on the backside 340, may be shown of the front side 342 of protective pad 370. This may be helpful, because when installing protective pad 370, the installer may have a better view of the front side 342, as compared to the backside 340, of protective pad 370.

In at least one of the preferred embodiments, the first and second pad fastener surfaces 334/336 include hook material to couple with the loop material of the inner and outer jamb fastener surfaces 344/346 respectively. In other embodiments, the pad fastener surface may include loop material and the jamb fastener surfaces may include hook material.

In some embodiments, protective pad 370 includes folding stitch line 338. Folding stitch line 338 may couple the backside 340 to the front side 342 of protective pad 370. Folding stitch line 338 may be visible from both the backside 340 and the front side 342 of protective pad 370. Folding stitch line 338 enables a crisp fold in protective pad 370 so that the pad may wrap around the corner formed by right inner jamb 314 and right outer jam 316. Other stitch lines may be adapted for other corners or entranceway geometries.

Folding stitch line 338 is disposed intermediate the longitudinal edges of protective pad 370. As shown in FIG. 3, folding stitch line 338 is positioned closer to the longitudinal edge that is substantially adjacent to second pad fastener surface 336 than to first pad fastener surface 334. This is to accommodate the specific geometry of entranceway 300. However, the various embodiments are not so constrained, and in other embodiments, folding stitch line 338 may be positioned closer to the other longitudinal edge, depended upon the corner to be protected.

Means other than folding stitch line 338 may be employed for creating crisp folds in protective pad 370. For instance, although not shown, protective pad 370 may include segmented or at least partially segmented portions that allow for folding, bending, or otherwise articulating protective pad 370. Likewise, the density of padding material may be varied throughout protective pad 370 to create portions that are more or less flexible than other portions. The non-uniform distribution of padding material may be secured with the use of baffles or other stitch lines.

In various embodiments, protective pad 370 includes numerous padding stitch lines 332, to form padding baffles 330, or padding channels. Padding baffles 330 may serve to stabilize, secure, and/or anchor padding material located between the backside 340 and the front side 342 of protective pad 370. As with folding stitch line 338, padding stitch lines 332 may couple and be visible from both the backside 340 and the front side 342 of protective pad 370. In a preferred embodiment, folding stitch line 338 is constructed with at least one of a heavier stitch gauge and/or heavier thread than the padding stitch lines 332.

Also shown in FIG. 3 is the thickness 348 relative to the height and width, or longitudinal and lateral dimensions, of protective pad 370. Protective pad's 370 relative low profile enhances the ability to bend, fold, or otherwise articulate protective pad 370 around corners and angled surfaces. Significantly, the low profile allows for the installation of protective pad 370 without substantially decreasing the clearance of entranceway 300. In various embodiments, the installation of protective pad 370 decreases the clearances by less than 10%, 5%, 1%, 0.5%, or 0.1%.

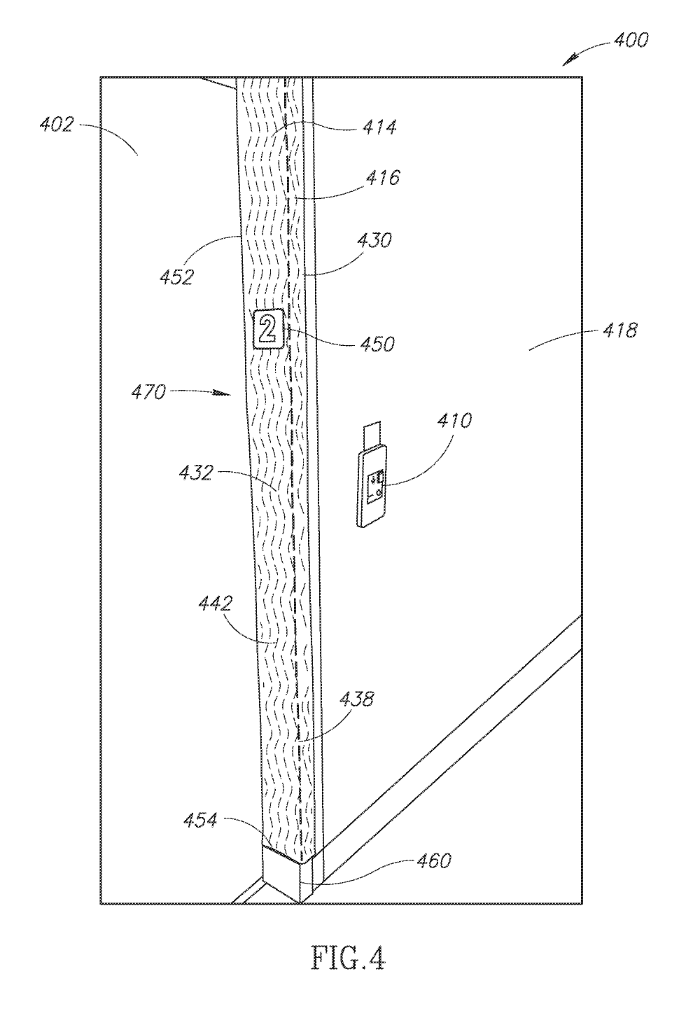

FIG. 4 shows another embodiment of an entranceway protection kit that is protecting a right-side portion of an elevator entranceway 400. Protected elevator entranceway 400 is at least partially protected from impacts via protective pad 470 that is coupled to portions of the entranceway frame. As can be observed in FIG. 4, elevator entranceway 400 includes elevator door 402, external control panel 410, and right wall 418. Elevator entranceway 400 additionally includes right inner jamb 414 and right outer jamb 416. However, right inner jamb 414 and right outer jamb 416 are hidden from view in FIG. 4 because protective pad 470 is covering them.

Protective pad 470 includes folding stitch line 438 that enables the crisp folding of protective pad 470. The folding or bending of protective pad 470 allows for covering of the entranceway corner that is created by the generally orthogonal surfaces of right inner jamb 414 and right outer jamb 416.

The front side 442 of protective pad 470 is shown in FIG. 4, however the backside of protective pad 470 is hidden from view because, when coupled to entranceway 400, the backside is adjacent to right inner jamb 414 and right outer jamb 416. Protective pad 470 includes padding stitch lines 432 to form padding baffles 430. Padding baffles 430 stabilize, secure, and/or anchor padding material included in protective pad 470.

As show in FIG. 4, protective pad 470 has been tailored and customized to the specific geometry of elevator entranceway 400, including the orientation and positioning of folding stitch line 438. The length and the width of protective pad 470 have been tailored to precisely match the linear dimensions, locations, and orientations of the surfaces and corners to be protected, such as right inner jamb 414 and right outer jamb 416, as well as the corner formed by the intersection of right inner jamb 414 and right outer jamb 416. This tailoring includes tailoring the lateral edge 454, positioned at the lower portion of protective pad 470 to fit snuggly and securely around floor trim 460. In some embodiments, the lateral edges may be secured to entranceway surfaces via the employment of further fasteners coupled to protective pad 470 and entranceway 400.

Protective pad 470 also includes tailored longitudinal edge 452. Although, hidden from view, a fastener, such as first pad fastener surface 334 of FIG. 3, is disposed on the backside of protective pad 470 and adjacent and/or substantially parallel with tailored longitudinal edge 452.

When coupled to entranceway 400, tailored longitudinal edge 452 is adjacent to, but does not interfere the operation of, elevator door 402. Thus, protective pad 470 protects substantially the entirety of right inner jamb 414, but leaves enough gap between protective pad 470 and elevator door 402 to ensure proper operation of the elevator. Also, note that the low profile of protective pad 470 does not interfere with, or otherwise substantially reduce the clearance of entranceway 400.

Various embodiments include a display means 450 to display a floor number or other pertinent information of the front side 452 of protective pad 470. As shown in FIG. 1, some entranceways include an entranceway floor indicator 158. In such cases, protective pad 470 may be tailored to include a transparent, or at least a partially transparent window. The window may be positioned such that, when protective pad 470 is coupled to entranceway 400, the entranceway floor indicator, which may otherwise be covered by protective pad 470, may be visible through display means 450, such as the window. The window may be constructed with transparent plastic, vinyl, Mylar®, or any other suitable partially or completely transparent or translucent material. In various embodiments, the display means 450 may be an isinglass window.

In various other embodiments, display means 450 may include a transparent, translucent, or partially transparent envelop provided on the front side 442 of the protective panel 470, such that an information-bearing sheet, placard, or other surface may be inserted into the envelope. In this way, information on the information-bearing surface is plainly visible when protective pad 470 is coupled to entranceway 400. In at least one embodiment, the display means 450 may be an isinglass envelope.

In at least one embodiment, display means 450 includes a fastener coupled to the front surface of protective pad 470. Such fasteners may include a swatch or area of material fastener such as hook or loop material. An information-bearing surface such as a placard, sheet, or another swatch of material may be removably coupled to the fastener material to outwardly display the information included on the information-bearing surface. For instance, a swatch of loop material may be coupled to the front side 442 of protective pad 470, with the use of stitches, adhesives, or any other suitable coupling means. An information-bearing swatch of material may be removably coupled to the loop material with mating hook material included on the side of the information-bearing swatch that does not include the information to make displayable.

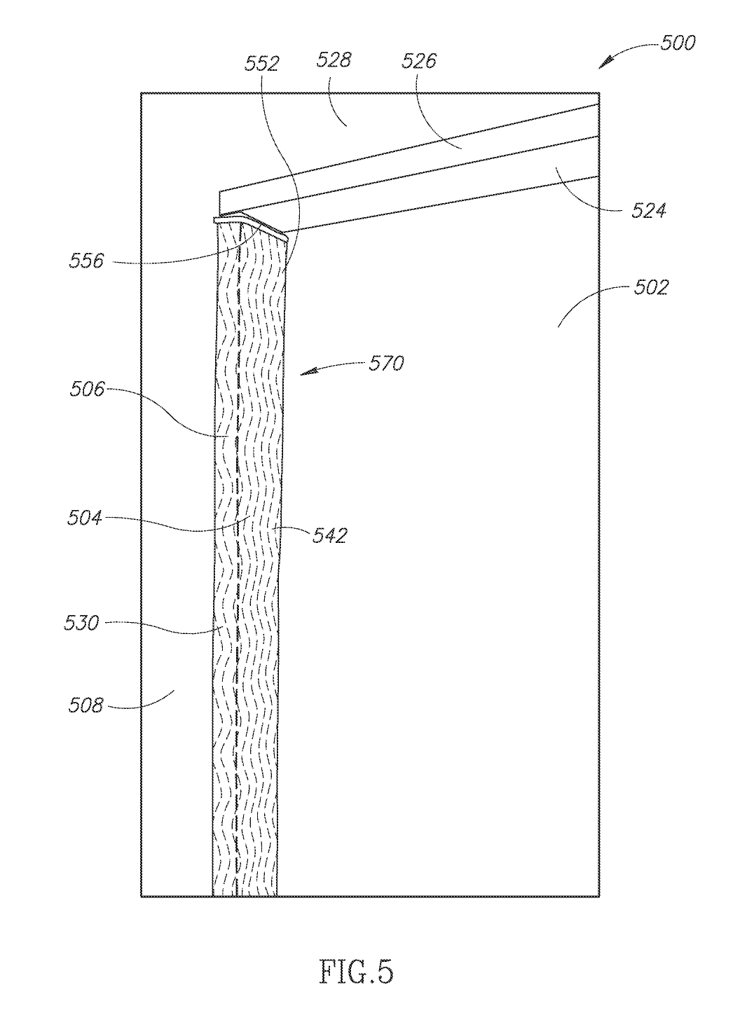

FIG. 5 shows yet another embodiment of an entranceway protection kit that is protecting a left-side portion of elevator entranceway 500. Protected elevator entranceway 500 is at least partially protected from impacts via the protective pad 570 that is coupled to portions of the entranceway frame. As can be observed in FIG. 5, elevator entranceway 500 includes elevator door 502, left wall 508, and upper wall 528. Elevator entranceway 500 additionally includes left inner jamb 504 and left outer jamb 506. However, left inner jamb 504 and left outer jamb 506 are hidden from view in FIG. 5 because protective pad 570 is covering them.

The front side 542 of protective pad 570 is shown in FIG. 5, however the backside of protective pad 570 is hidden from view because, when coupled to entranceway 500, the backside is adjacent to left inner jamb 504 and left outer jamb 506. Protective pad 570 includes padding baffles 530 or padding channels. Padding baffles 530 stabilize, secure, and/or anchor padding material included in protective pad 570. In some embodiments, customized or tailored padding baffles may be employed to form and stabilize non-uniform distributions to create portions of protective pad 570 that may include less or more padding material. This may allow for the formations of bendable, foldable, or articulable regions of protective pad 570. Additional, segmented or partially segmented portions of protective pad may be formed by the use of specialized padding baffles.

Protective pad 570 has been tailored to fit entranceway 500, including tailored lateral edge 556. As shown in FIG. 5, tailored lateral edge 556 includes an extra volume of protective padding material. This tailoring may be accomplished via baffles and/or additional stitch lines. Furthermore, tailored longitudinal edge 552 has been tailored to be flush with elevator door 502. Longitudinal edge 552 has been tailored to leave enough gap to not interfere with the operation of elevator door 502, but to fully cover right inner jamb 504.

Entranceway 500 additionally includes inner lintel 524 and outer lintel 526. Although not shown, these surfaces may be protected with the various embodiments of entranceway protection kits and protection methods disclosed here. As is readily apparent, once jamb fasteners, such as inner jamb fasteners 344 and outer jamb fasteners 346 of FIG. 3 are coupled to the entranceway to be protected, there are not discrete elements included in or employed in the various embodiments disclosed herein, that are small enough to fall in an elevator shaft through a gap between an elevator door and the floor.

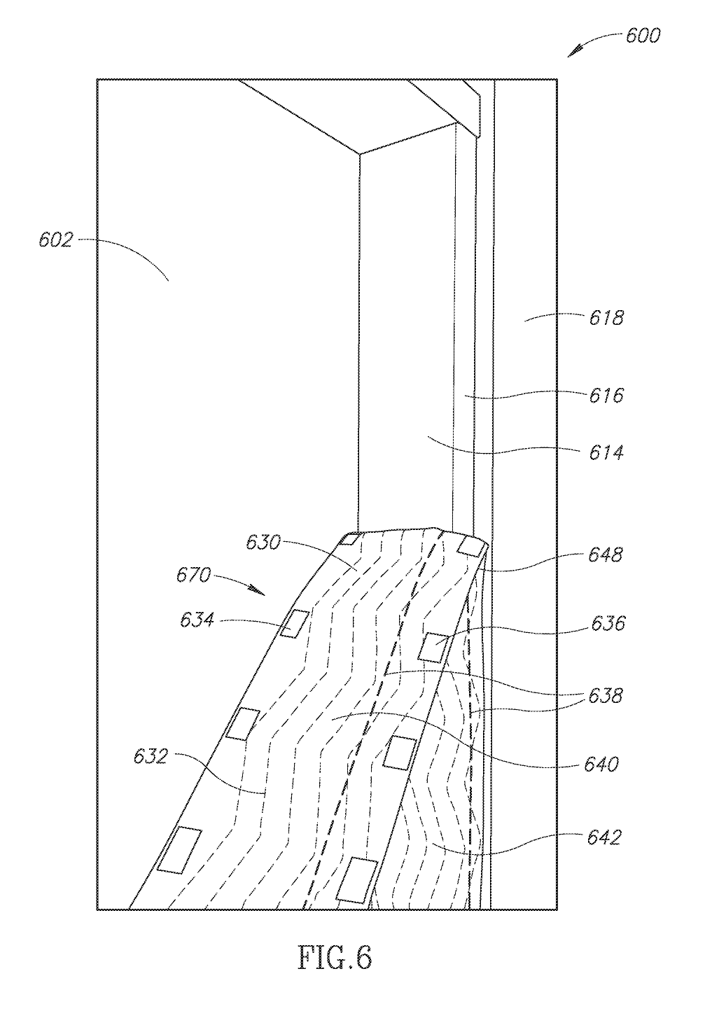

FIG. 6 shows an alternative embodiment of an entranceway protection kit in mid-installation (or mid-removal) in an entranceway, such as the entranceway shown in FIG. 1, to protect the entranceway. The view is similar to the view shown in FIG. 3. Elevator entranceway 600 includes elevator door 602 and right wall 618. Elevator entranceway 600 also includes right inner jamb 614, which includes a right inner surface, and right outer jamb 616, which includes a right outer surface. In some embodiments, at least one of the jamb surfaces may include ferrous materials, such as steel. When placed in close proximity, magnets couple to such surfaces that include ferrous materials.

An alternative embodiment of a protective pad 670 is shown partially coupled to and partially protecting right inner jamb 614 and right outer jamb 616. Protective pad 670 includes at least one inner magnet 634. In some embodiments, protective pad 670 includes a plurality of inner magnets, aligned along the inner edge of protective pad 670, as illustrated in FIG. 6. Likewise, protective pad 670 includes at least one outer magnet 636. As also shown, protective pad 670 includes a plurality of outer magnets, aligned along the inner edge of protective pad 670.

Each of these magnets is coupled to protective pad 670. Magnets may be coupled to the backside surface 640 of protective pad 670. Such coupling may be enabled with an adhesive or epoxy, such as a glue. In other embodiments, the magnets are sewn into or onto a surface of protective pad 670. The magnets may be embedded inside protective pad 670, between the inner and outer surfaces, such that the magnets are not visible from the outside of protective pad 670. When embedded inside protective pad 670, the magnets may be stabilized with stitches or tackings. In at least one embodiment, at least one of the magnets is coupled, with an adhesive or stitches, to the front side surface 642 of protective pad 670.

The magnets may be a fastener surface. As shown in FIG. 6, protective pad 670 is removably coupled to right inner jamb 614 by the plurality of inner magnets, including inner magnet 634. Likewise, protective pad 670 is removably coupled to right outer jamb 616 by the plurality of outer magnets, including outer magnet 636. The magnetics may include any style of magnet, including common refrigerator-style magnets with alternating north and south poles. In a preferred embodiment, the strength of the magnetic coupling of protective pad 670 to right inner jamb 614 and right outer 616 is great enough to support the mass of protective 670. Rare earth magnets may be used for extra strength.

In some embodiments, the number and longitudinal spacing of the magnets are based on the strength of the magnets and the mass of the protective pad 670. For instance, if protective pad 670 is relatively massive, more magnets and/or closer spacing of the magnets may be employed. Likewise, if the dipole strength of the magnets is relatively strong, less magnets and/or greater spacing of the magnets may be employed. Accordingly, various embodiments may include a greater number or a lesser number of magnets as illustrated in FIG. 6. The magnets may be spaced closer together or further apart as illustrated in FIG. 6.

Protective pad 670 includes folding stitch lines 638. Protective pad 670 may also include a plurality of padding stitch lines 632 that form padding baffles 630. The thickness 648 of protective pad may be such that protective pad 670 is a low profile pad.

All of the embodiments and methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. An entranceway protection kit configured and arranged to protect at least a portion of an entranceway that includes a first entranceway surface, the entranceway protection kit comprising:
a protective pad that includes a first pad surface, a second pad surface in opposition to the first pad surface, and padding material disposed intermediate the first and the second pad surfaces; and
a first pad fastener surface coupled to the second pad surface, the first pad fastener surface being configured and arranged to removably couple to a first entranceway fastener surface that is removably coupled to the first entranceway surface, wherein the first entranceway fastener surface is coupled to the first entranceway surface such that the protective pad is removably couplable to the first entranceway surface.

2. The entranceway protection kit of claim 1, further comprising:
a second pad fastener surface coupled to the second pad surface, the second pad fastener being configured and arranged to removably couple to a second entranceway fastener surface, wherein the second entranceway fastener surface is coupled to a second entranceway surface such that the protective pad is removably couplable to the second entranceway surface, and
wherein the first pad fastener surface is a first strip of fastener material that is disposed on the second pad surface and is substantially adjacent to and extends longitudinally along at least a portion of a first longitudinal edge of the protective pad and the second pad fastener surface is a second strip of fastener material that is disposed on the second pad surface and substantially adjacent to and extends longitudinally along at least a portion of a second longitudinal edge of the protective pad.

3. The entranceway protection kit of claim 2, wherein the first strip of fastener material, the second strip of fastener material, the first longitudinal edge, and the second longitudinal edge of the protective pad are substantially parallel and each are oriented substantially vertical when the protective pad is removably coupled to the first entranceway surface and the second entranceway surface.

4. The entranceway protection kit of claim 1, wherein the first pad fastener surface includes a first fastener material that covers at least a portion of a surface area of the second pad surface and the first pad fastener surface is further configured and arranged to simultaneously couple to a plurality of entranceway fastener surfaces that each include a second fastener material.

5. The entranceway protection of claim 1, wherein
the first pad fastener surface includes an area of a first fastener material and the first pad fastener surface is defined by a pad fastener length and a pad fastener width, wherein the pad fastener length is substantially greater than the pad fastener width and wherein
the first entranceway fastener surface includes an area of a second fastener material and the first entranceway fastener surface is defined by an entranceway fastener length and an entranceway fastener width, wherein the entranceway fastener width is larger than the pad fastener width.

6. The entranceway protection kit of claim 5, wherein the pad fastener width is approximately 1 inch and the entranceway fastener width is approximately 2 inches.

7. The entranceway protection kit of claim 5, wherein the pad fastener length is approximately equal to a length of the protection pad.

8. The entranceway protection kit of claim 1, further comprising
a second pad fastener surface coupled to the second pad surface, the second pad fastener surface being configured and arranged to removably couple to a second entranceway fastener surface, wherein the second entranceway fastener surface is coupled to a second entranceway surface such that the protective pad removably couplable to the second entranceway surface and wherein the first entranceway surface and the second entranceway surface form an entranceway corner, and wherein
the protective pad further includes a folding stitch line disposed intermediate the first pad fastener surface and the second pad fastener surface, the folding stitch line being configured and arranged to enable folding the protective pad around the entranceway corner.

9. The entranceway protection kit of claim 8, wherein the first pad fastener surface is substantially adjacent to a first longitudinal edge of the protective pad and the second pad fastener surface is substantially adjacent to a second longitudinal edge of the protective pad and the folding stitch line is a longitudinal stitch line substantially parallel with each of and disposed intermediate the first longitudinal edge and the second longitudinal edge of the protective pad.

10. The entranceway protection kit of claim 8, wherein the folding stitch line is closer to one of the first or the second pad fastener surfaces than the other first or second pad fastener surfaces.

11. The entranceway protection kit of claim 1, wherein the entranceway further includes a door oriented substantially orthogonal to the first entranceway surface, the door being disposed adjacent to a longitudinal edge of the first entranceway surface, and wherein the protective pad further includes a longitudinal pad edge that, when the protective pad is coupled to the first entranceway surface, is disposed adjacent to both the door and the longitudinal edge of the first entranceway surface.

12. The entranceway protection kit of claim 1, wherein the first entranceway surface is a first inner surface and the entranceway further includes a second inner surface in opposition to the first inner surface and the entranceway is defined by an entranceway clearance based on a distance separating the first inner surface and the second inner surface and when the protective pad is coupled to the first inner surface, the entranceway clearance remains substantially unchanged.

13. The entranceway protection kit of claim 1, wherein the protective pad further includes a window that is at least partially transparent to enable viewing of at least a portion of at least one of the inner entranceway surface or the outer entranceway surface when the protective pad is coupled to the entranceway.

14. The entranceway protection kit of claim 1, wherein the protective pad further includes an envelope that is at least partially transparent and disposed on a first pad surface, wherein the envelope is configured and arranged to receive an information-bearing surface.

15. The entranceway protection kit of claim 1, wherein the first entranceway fastener surface is removably coupled to the first entranceway surface by an adhesive.

16. The entranceway protection kit of claim 1, wherein the first pad fastener surface is coupled to the second pad surface by at least stitches.

17. The entranceway protection kit of claim 1, wherein the protective pad further comprises baffles to stabilize the padding material.

18. A method for protecting an entranceway, the method including:
coupling a first entranceway fastener to an inner entranceway surface;
coupling a second entranceway fastener to an outer entranceway surface where the inner and the outer entranceway surfaces form an entranceway corner such that the first entranceway fastener is oriented substantially orthogonal to the second entranceway fastener and at least one of the first entranceway fastener or the second entranceway fastener is a fastener surface;
aligning a protective pad that includes a first pad fastener and a second pad fastener, each of the pad fasteners disposed on a second pad surface, wherein the protective pad is aligned such that the first pad fastener is adjacent to the first entranceway fastener, the second pad fastener is adjacent to the second entranceway fastener, and the protective pad substantially wraps around the entranceway corner; and
coupling the protective pad to the entranceway by removably coupling the first pad fastener to the first entranceway fastener and removably coupling the second pad fastener to the second entranceway fastener.

19. The method of claim 18, further including folding the protective pad about a folding stitch line of the protective pad so that the protective pad substantially wraps around the entranceway corner.

20. The method of claim 18, further comprising:
coupling a third entranceway fastener to the inner entranceway surface such that the third entranceway fastener is below the first entranceway fastener;
coupling a fourth entranceway fastener to the outer entranceway surface such that the fourth entranceway fastener is below the second entranceway fastener;
removably coupling the first pad fastener to the third entranceway fastener; and
removably coupling the second pad fastener to the fourth entranceway fastener.

21. The method of claim 18, wherein the first entranceway fastener is coupled to the inner entranceway surface with an adhesive.

22. The method of claim 18, wherein the protective pad further includes a window that is at least partially transparent to enable viewing of at least a portion of at least one of the inner entranceway surface or the outer entranceway surface when the protective pad is coupled to the entranceway.

23. The method of claim 18, wherein the protective pad further includes a third pad fastener disposed on a first pad surface, wherein the third pad fastener is configured and arranged to enable the coupling of an information-bearing surface to the first pad surface.

24. The method of claim 18, wherein the protective pad further includes an envelope that is at least partially transparent and disposed on a first pad surface, wherein the envelope is configured and arranged to receive an information-bearing surface.

25. The method of claim 18, wherein the protective pad is a low-profile protective pad, such that when coupled to the entranceway, a clearance of the entranceway remains substantially constant.

26. An entranceway protection kit configured and arranged to protect an inner entranceway surface and an outer entranceway surface of an entranceway, wherein the inner entranceway surface and the outer entranceway surface form a corner in the entranceway, the protection kit comprising:
a first entranceway fastener that is configured and arranged for coupling to the inner entranceway surface;
a second entranceway fastener that is configured and arranged for coupling to the outer entranceway surface; and
a protective pad comprising:
a first pad fastener disposed on a second pad surface and substantially adjacent to a first longitudinal edge of the protective pad, wherein the first pad fastener is configured and arranged to couple to the first entranceway fastener; and
a second pad fastener disposed on the second pad surface and substantially adjacent to a second longitudinal edge of the protective pad, wherein the second pad fastener is configured and arranged to couple to the second entranceway fastener,
wherein the protective pad is coupled to the entranceway by employing the first and the second pad fasteners and the first and the second entranceway fasteners and at least one the first or the second pad fasteners extends along the corresponding longitudinal edge of the protective pad.

27. The entranceway protection kit of claim 26, further comprising:
a folding stitch line oriented in a longitudinal direction of the protective pad, the folding stitch line disposed intermediate the first longitudinal edge and the second longitudinal edge and substantially parallel to each of the longitudinal edges, the folding stitch line being configured and arranged to enable folding the protective pad about the folding stitch line so that that the protective pad wraps around the corner of the entranceway.

28. The entranceway protection kit of claim 26, wherein the first pad fastener and the second pad fastener are each approximately 1 inch wide and the first entranceway fastener and the second entranceway fastener are each approximately 2 inches wide.

29. The entranceway protection kit of claim 26, wherein the first entranceway fastener is removably coupled to the inner entranceway surface by an adhesive.

30. The entranceway protection kit of claim 26, wherein the protective pad further includes a window that is at least partially transparent to enable viewing of at least a portion of at least one of the inner entranceway surface or the outer entranceway surface when the protective pad is coupled to the entranceway.

31. The entranceway protection kit of claim 26, wherein the protective pad further includes a third pad fastener disposed on a first pad surface, wherein the third pad fastener is configured and arranged to enable the coupling of an information-bearing surface to the first pad surface.

32. The entranceway protection kit of claim 26, wherein the protective pad further includes an envelope that is at least partially transparent and disposed on a first pad surface, wherein the envelope is configured and arranged to receive an information-bearing surface.

33. The entranceway protection kit of claim 26, wherein the protective pad is a low-profile protective pad, such that a clearance of the entranceway when the protective pad is coupled to the entranceway is substantially the same as a clearance of the entranceway remains when the protective pad is not coupled to the entranceway.

34. The entranceway protection kit of claim 26 that comprises at least a total of three entranceway fasteners.

35. The entranceway protection kit of claim 26 that further comprises at least one tailored lateral edge.

36. The entranceway protection kit of claim 26 that further comprises at least one tailored longitudinal edge.

37. An entranceway protection kit configured and arranged to protect at least a portion of an entranceway that includes a first entranceway surface, the entranceway protection kit comprising:
a protective pad that includes a first pad surface, a second pad surface in opposition to the first pad surface, and padding material disposed intermediate the first and the second pad surfaces; and
a first pad magnet that is coupled to the protective pad, the first pad magnet being configured and arranged to removably couple to the first entranceway surface, such that the protective pad is removably couplable to the first entranceway surface.

38. The entranceway protection kit of claim 37, wherein the first pad magnet is coupled to the first pad surface by an adhesive.

39. The entranceway protection kit of claim 37, wherein the first pad magnet is disposed intermediate the first pad surface and the second pad surface and at least partially stabilized by stitches.

40. The entranceway kit of claim 37, further comprising
a first plurality of longitudinally-spaced-apart magnets that are aligned along a first longitudinal edge of the protective pad; and
a second plurality of longitudinally-spaced-apart magnets that are aligned along a second longitudinal edge of the protective pad.
